(19) United States
(12) Patent Application Publication
(10) Pub. No.: US 2010/0250804 A1
(43) Pub. Date: Sep. 30, 2010

(54) METHOD FOR IC COMMUNICATION SYSTEM

(75) Inventors: Jan Pang Lim, Singapore (SG); Shao Shan Wu, Singapore (SG)

Correspondence Address: GREENBLUM & BERNSTEIN, P.L.C., 1950 ROLAND CLARKE PLACE, RESTON, VA, 20191, US

(73) Assignees: PANASONIC CORPORATION, Osaka (JP); PANASONIC SEMICONDUCTOR ASIA PTE., LTD., Singapore (SG)

(21) Appl. No.: 12/409,745

(22) Filed: Mar. 24, 2009

(51) Int. Cl. G06F 13/40

(52) U.S. Cl. 710/110

(57) ABSTRACT

A method of optimizing the usage of communication buses is disclosed. In this method, a slave may function, when necessary, as a ‘pseudo-master’. This allows direct communication between slaves, one of which functions as a ‘pseudo-master’. This hence relieves the Master device of the load required as an intermediary for the communication of said slaves.

### BACKGROUND OF THE INVENTION

The present invention relates to the IC bus communication, typically from the microcontroller (master) to various ICs (slave).

In a typical system, the master is connected to multiple slave ICs through a common communication bus. The communication protocol through the bus is common to all the ICs connected. Thus, the master can only communicate with one slave at a time. In order to pass instructions and/or monitor the status of the slaves, the master will have to do polling.

A conventional method of transferring data from slave A to slave B is described below as case 1.

Referring to FIG. 1 which shows the conventional communication bus between the master and the slave. As a first step, the master checks the status of slave A. If slave A is in a condition such that it is able to transfer data to slave B, the master will then send an instruction signal to slave A to transfer that information to slave B. Slave A will hence transfer to slave B.

However, if slave A is in a condition such that it is NOT able to transfer data to slave B, the master will continue to check the status of slave C, followed by slave D, and so on, before looping back to check the status of slave A. In this scenario, the master will have to spend several cycles before it can transfer the information from slave A to slave B as the master have to send instructions through the communication bus one at a time.

A conventional method of obtaining data from slave A is described below as case 2.

Referring to FIG. 1 again, the steps taken by the master is similar. The master will check the status of slave A. If slave A is in a condition such that it is able to transfer data back to the master, the master will then send an instruction signal to slave A to transfer that information to the master. Slave A will hence transfer to the master.

As in Case 1, similarly, if the slave A is in a condition such that it is NOT able to transfer data to the master, the master will continue to check the status of slave C, followed by slave D, and so on, before looping back to check the status of slave A. The master will have to spend several cycles before slave A finally transfers the required data to the master.

Hence, as the number of slaves increase, the time for the master to obtain the necessary information from the slaves and to send the correct instructions to the slaves increase proportionally.

### SUMMARY OF THE INVENTION

The purpose of this invention is to provide a method to optimize the usage of the communication bus by allowing ‘pseudo master’ control.

According to one preferred embodiment of the present invention, a method of optimizing the utilization of a first communication bus, comprising:

establishing a second communication bus between a first slave device and a second slave device, upon instruction by the master device;

designating said first slave device as a pseudo-master;

enabling direct communications between said first slave device, now a pseudo-master, and said second slave device;

disabling the pseudo-master status of said first slave device upon instruction by the master device;

regaining control over said first and second slave devices by the master device.

According to another preferred embodiment of the present invention, a method of optimizing the utilization of a communication bus comprises:

designating a first slave device as a pseudo-master;

enabling the pseudo-master status of said first slave device upon instruction by the master device;

disconnecting said communication bus between a master device and said first slave device, and between said master device and a second slave device;

enabling direct communications between said first slave device, now a pseudo-master, and said second slave device;

disabling the pseudo-master status of said first slave device upon instruction by the master device;

regaining control over said first and second slave devices by the master device.

### BRIEF DESCRIPTION OF THE DRAWINGS

FIG. 1 is the block diagram showing the typical IC communication arrangement.

FIG. 2A is the block diagram of an IC communication system according to a first preferred embodiment of the present invention.

FIG. 2B is the block diagram of an IC communication system according to a second preferred embodiment of the present invention.

FIG. 2C is an exemplary usage of the present invention.

FIG. 3 is the block diagram of an IC communication system according to a third preferred embodiment based on the present invention.

FIG. 4A shows the flow chart demonstrating the implementation of an IC communication system according to the first preferred embodiment based on the present invention.

FIG. 4B shows the flow chart demonstrating the implementation of an IC communication system according to the second preferred embodiment based on the present invention.

FIG. 5 is the block diagram of an IC communication system according to a fourth preferred embodiment based on the present invention.

FIG. 6A shows the flow chart demonstrating the implementation of an IC communication system according to the third preferred embodiments based on the present invention.

FIG. 6B shows the flow chart demonstrating the implementation of an IC communication system according to the fourth preferred embodiments based on the present invention.

FIG. 7 is the block diagram of an IC communication system according to a fifth preferred embodiment of the present invention.

FIG. 8 is the block diagram of an IC communication system according to a sixth preferred embodiment of the present invention.

FIG. 9 is the block diagram of an IC communication system according to a seventh preferred embodiment of the present invention.

FIG. 10 is the block diagram of an IC communication system according to an eighth preferred embodiment of the present invention.

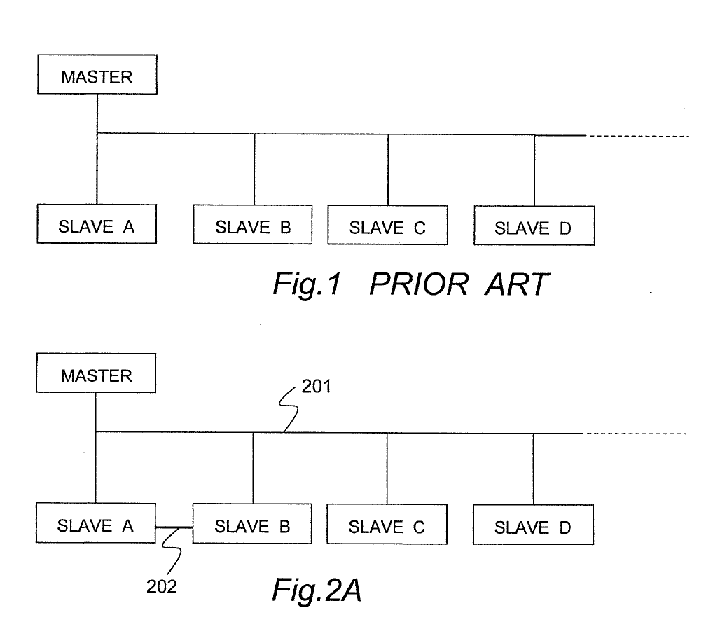

### DETAILED DESCRIPTION OF THE PREFERRED EMBODIMENTS

The following description explains the best mode embodiments of the present invention.

### First Embodiment

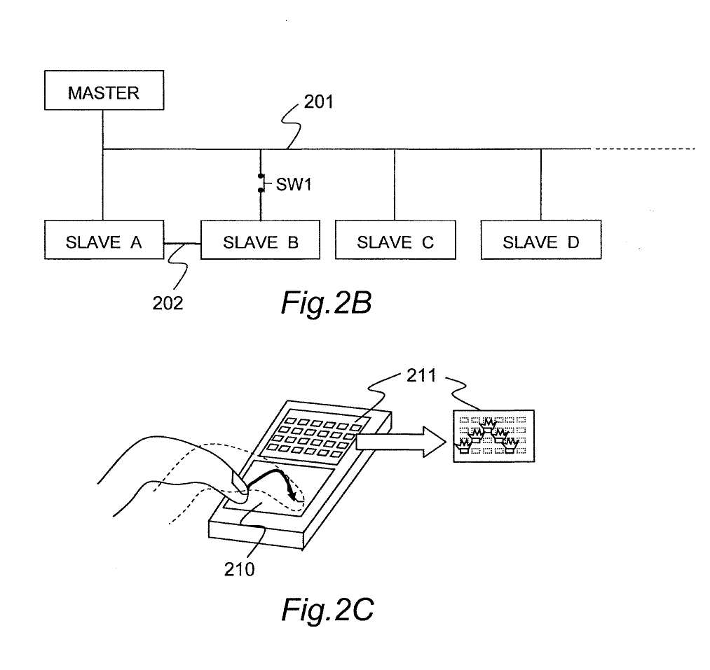

Referring to FIG. 2A, the construction of the first preferred embodiment of the IC communication system based on the present invention is described.

A Master device, for example a microcontroller, microprocessor or any device that is capable of gaining unidirectional control over the other slave devices in the system, shares a common communication bus 201 with slave devices: Slave A, Slave B, Slave C, Slave D and so on.

Depending on the requirements of the system, an additional communication bus may be added between slave devices. This new communication bus need not necessarily be of the same communication protocol with the master bus. It can be of some other conventional communication protocol (for example I2C, SPI, etc) or even some custom self-defined protocol.

According to exemplary condition 1, it is required that Slave A transfers data to Slave B

An example described by this condition is as follows, as shown in FIG. 2C:

Slave A is a capacitive touch sensor 210, Slave B is a LED display 211.

It is required that any motion sensed by the capacitive touch sensor is displayed real time via LED display.

Based on this exemplary condition, Slave A is expected to transfer the sensor information to Slave B. Hence, Slave A is, when instructed by the Master device, a Pseudo-Master. An additional communication bus 202 constructed between Slave A and Slave B is used for transferring the information between the two slave devices.

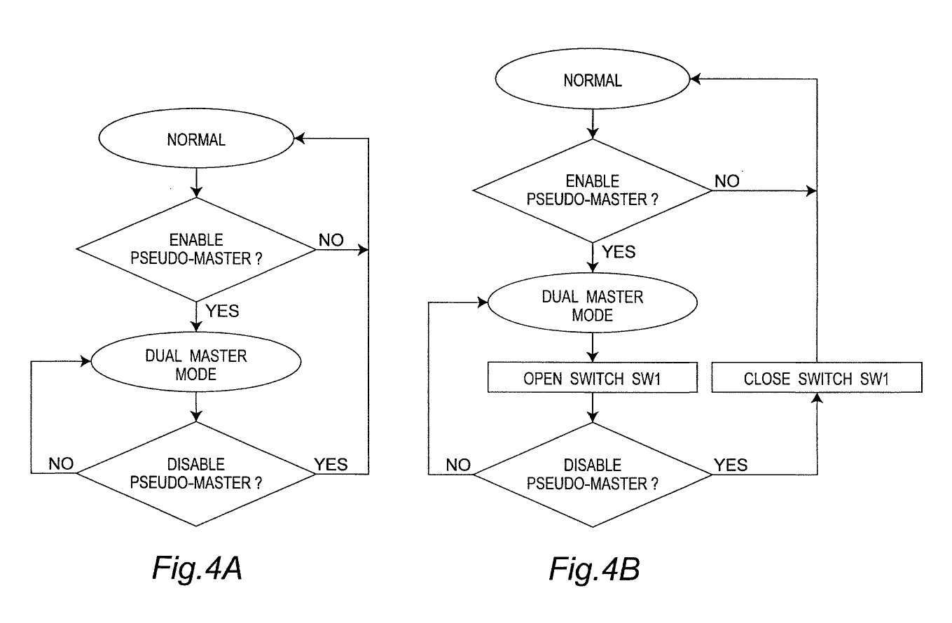

Referring to FIG. 4A, the method of sequence of operation of the first preferred embodiment of the IC communication system based on the present invention is described.

At default, the system works under the NORMAL (conventional) mode of operation. Under the NORMAL mode, the Master device can communicate with all the slaves. The pseudo-master is NOT enabled yet, hence, the pseudo-master is not able to control any slave devices.

When the need arises due to certain conditions, such as exemplary condition 1, the Master device hence decides to ‘ENABLE PSEUDO-MASTER’. This is achieved by sending an instruction via communication bus 201 to Slave A to enable its pseudo-master mode. Once this is done, the pseudo-master (Slave A) will thus control Slave B. Hence, (based on the exemplary condition 1) the capacitive touch sensor 210 will transfer its data DIRECT to LED display 211. As can be seen, Slave A now does not require the Master device to act as an intermediary to transfer the information to Slave B, unlike conventional protocols. At the same time, the Master device is still able to communicate with slave devices other than Slaves A and B to perform other functions. This mode is now termed as ‘DUAL MASTER MODE’. In the system level point of view, it would be equivalent to having two masters controlling the entire system. In this way, the load of the master will be lightened and hence, the efficiency of the master will be improved.

Once the exemplary condition I has passed, the Master device will decide to ‘DISABLE PSEUDO-MASTER’. This is achieved by sending an instruction via communication bus 201 to Slave A to disable its pseudo-master mode. Once this is done, communication between Slaves A and B via communication bus 202 will cease, and the system returns to the NORMAL mode of operation.

### Second Embodiment

Referring to FIG. 2B, the construction of the second preferred embodiment of the IC communication system based on the present invention is described.

The same elements and construction as the first embodiment is used, with the addition of a switch SW1 added on the communication bus 201 between the Master device and Slave B.

Referring to FIG. 4B, the method of sequence of operation of the second preferred embodiment of the IC communication system based on the present invention is described.

The method of sequence of operation for the second embodiment is similar to that for the first embodiment, with the addition that under the ‘DUAL MASTER MODE’, the Master device is completely disconnected from Slave B, by opening switch SW1. Likewise, when it is decided to ‘DISABLE PSEUDO-MASTER’, SW1 is closed, thus enabling the Master device to control Slave B.

### Third Embodiment

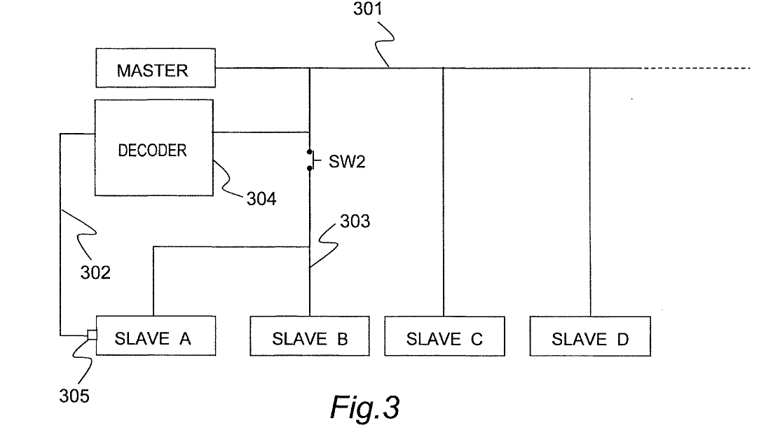

Referring to FIG. 3, the construction of the third preferred embodiment of the IC communication system based on the present invention is described.

A Master device shares a common communication bus 301 with slave devices: Slave C, Slave D and so on, except for Slaves A and B. This is because it has been pre-determined that Slaves A and B are required to communicate with each other independently from the Master device. A condition where such a situation occurs is as described by exemplary condition 1. The communication bus 301 is connected to Slaves A and B via switch SW2 and communication bus 303, where communication buses 303 and 301 use the same communication protocol. The Master device is also connected to Slave A via a Decoder 304 and communication bus 302, where communication buses 302 and 301 use the same communication protocol.

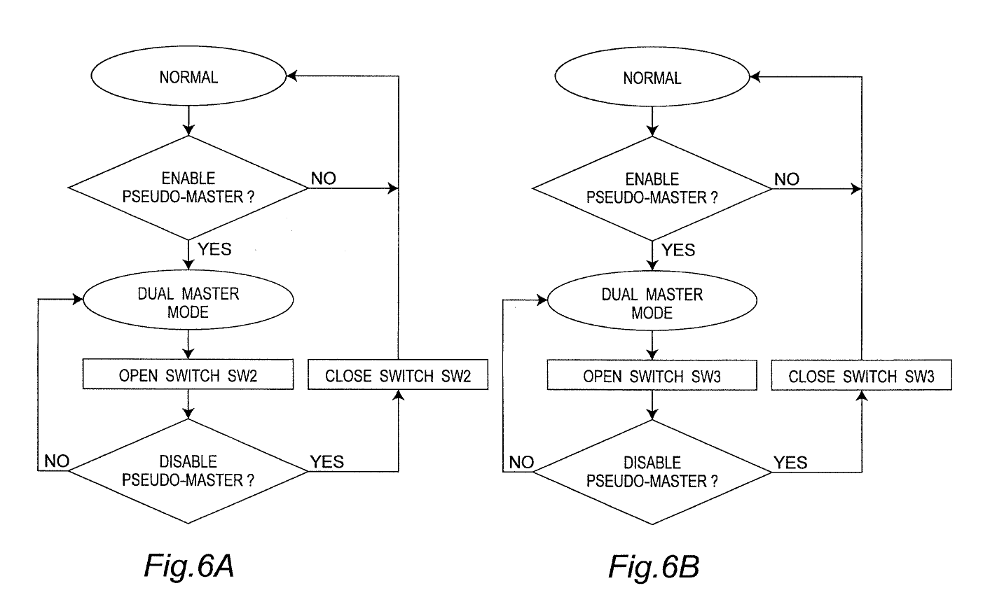

Referring to FIG. 6A, the method of sequence of operation of the third preferred embodiment of the IC communication system based on the present invention is described.

At default, the system works under the NORMAL (conventional) mode of operation. Under the NORMAL mode, the Master device can communicate with all the slaves. The pseudo-master is NOT enabled yet, hence, the pseudo-master is not able to control any slave devices.

When the need arises due to certain conditions, such as exemplary condition 1, the Master device hence decides to ‘ENABLE PSEUDO-MASTER’. This is achieved by sending a control signal via communication bus 301 and decoder 304 to control pin 305 of Slave A to enable its pseudo-master mode. Here, the decoder 304 is used to decode the control signal from the Master device. The decoder 304 is particularly useful when there is insufficient pins for the Master device to send control signals to Slave A. Once this is done, the pseudo-master (Slave A) will thus control Slave B. Switch SW2 is also opened so as to open any direct connections between the Master device and Slaves A and B. Hence, (based on the exemplary condition 1) the capacitive touch sensor 210 will transfer its data DIRECT to LED display 211 via communication bus 303. As can be seen, Slave A now does not require the Master device to act as an intermediary to transfer the information to Slave B, unlike conventional protocols. At the same time, the Master device is still able to communicate with slave devices other than Slaves A and B to perform other functions. This mode is now termed as ‘DUAL MASTER MODE’. As with the first and second preferred embodiments, in the system level point of view, it would be equivalent to having two masters controlling the entire system. In this way, the load of the master will be lightened and hence, the efficiency of the master will be improved.

Once the exemplary condition 1 has passed, the Master device will decide to ‘DISABLE PSEUDO-MASTER’. This is achieved by sending a control signal via communication bus 301 and decoder 304 to control pin 305 of Slave A to disable its pseudo-master mode. Switch SW2 is also closed. Once this is done, communication between Slaves A and B via communication bus 303 will cease, and the system returns to the NORMAL mode of operation.

### Fourth Embodiment

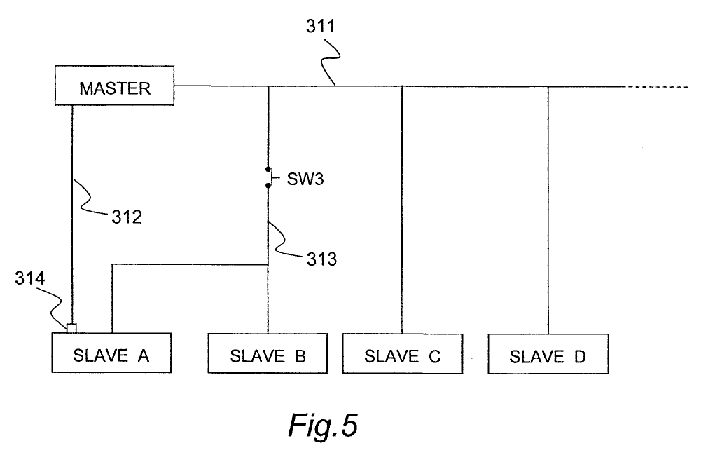

Referring to FIG. 5, the construction of the fourth preferred embodiment of the IC communication system based on the present invention is described.

The same elements and construction as the third embodiment is used, with the only differences being such that:
1. The decoder 304 has been removed; and
2. A direct wired connection 312 is made from the Master device to the control pin 314 of Slave A.

Referring to FIG. 6B, the method of sequence of operation of the fourth preferred embodiment of the IC communication system based on the present invention is described.

The method of sequence of operation for the fourth embodiment is similar to that for the third embodiment, with the only difference being the means to enable or disable the pseudo-master mode, as described as follows:

When the need arises due to certain conditions, such as exemplary condition 1, the Master device decides to ‘ENABLE PSEUDO-MASTER’. This is achieved by sending a control signal via the wired connection 312 to control pin 314 of Slave A to enable its pseudo-master mode.

Likewise, when it is decided to ‘DISABLE PSEUDO-MASTER’, the Master device will send a control signal via wired connection 312 to control pin 314 of Slave A to disable its pseudo-master mode. Switch SW3 is also closed. Once this is done, communication between Slaves A and B via communication bus 313 will cease, and the system returns to the NORMAL mode of operation.

As can be seen from the embodiments, the efficiency of the master is improved since there are two less slaves for it to control. This method can be modified further such that there is more than one pseudo master. Note that each pseudo master controls one slave. Hence, for each pseudo master added the load of the master IC is decreased by two.

### Fifth Embodiment

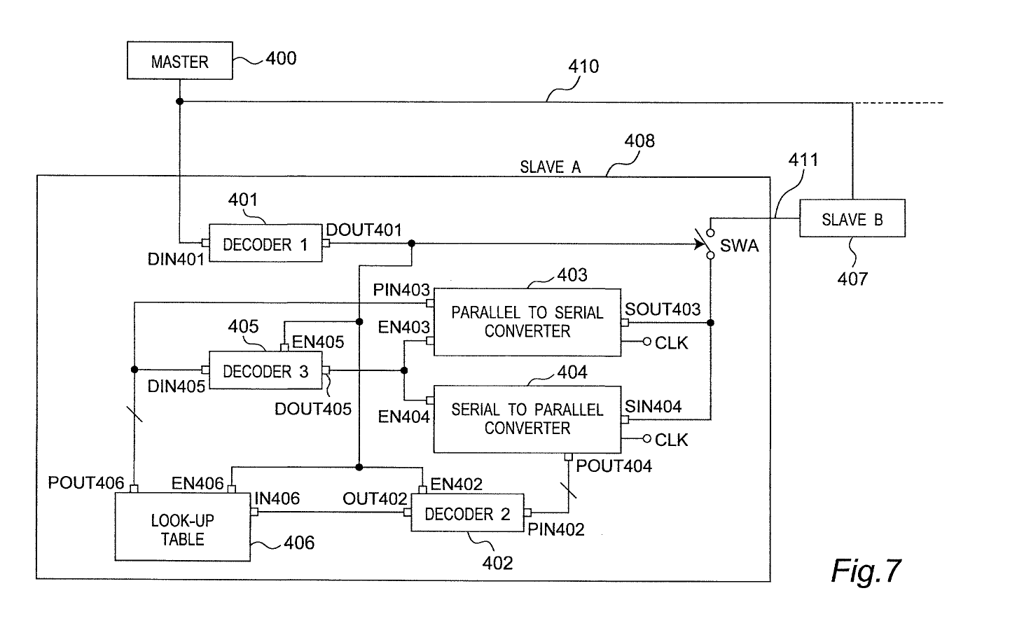

Referring to FIG. 7, an implementation to realize the fifth embodiment of the IC communication system based on the present invention is described.

The Master device 400 is connected to Slaves A 408 and B 407 via communication bus 410, as described in the first embodiment. Similarly, there is an additional communication bus 411 constructed between the two slave devices 408 and 407. Both communication buses 410 and 411 can be of conventional communication protocol (for example I2C, SPI, etc) or even some custom self-defined protocol. Also, both communication buses 410 and 411 may use the same communication protocol or different from each other.

As shown, Slave A 408 has Parallel to Serial converter 403, Serial to Parallel converter 404, Look-up Table 406, switch SWA and decoders Decoder1 401, Decoder2 402 and Decoder3 405. Parallel to Serial converter 403 and Serial to Parallel converter 404 accept clock pulse signals via their CLK inputs.

When the need arises due to certain conditions, such as exemplary condition 1, the Master device 400 hence decides to ‘ENABLE PSEUDO-MASTER’. The operation of the Pseudo-Master is described as follows:

Master device 400 sends an instruction to initiate the Pseudo-Master mode via communication bus 410 to input DIN401 of Decoder1 401. Upon receiving the instruction, Decoder1 401 sends out a signal INITP via output DOUT401 to the enable pins EN402, EN405 and EN406 of Decoder2 402, Decoder3 405 and Look-up table 406 respectively, as well as close switch SWA.

Once enabled, Look-up table 406 sends out a default parallel data DATA0 via output POUT406 to input PIN403 of Parallel to serial converter 403 and to input DIN405 of Decoder3. Upon receipt of the data, Decoder3 sends out a signal S1 via output DOUT405 to inputs EN403 of Parallel to Serial Converter block 403 and EN404 of Serial to Parallel Converter block 404. This results in the following:

Parallel to Serial Converter block 403 is enabled.

Serial to Parallel Converter block 404 is disabled.

The enabled Parallel to Serial Converter block 403 converts the DATA0 from parallel to serial form and outputs the serial form of DATA0 to Slave B 407 via communication bus 411. At this stage, Slave A 408 is thus assuming the Pseudo-Master mode, and is communicating directly to Slave B 407 without requiring the Master device 400 to act as an intermediary to transfer the information to Slave B, unlike conventional protocols.

Upon completion of the transfer of DATA0 to Slave B, Decoder3 405 sends out a signal S2 to inputs EN403 of Parallel to Serial Converter block 403 and EN404 of Serial to Parallel Converter block 404. This results in the following:

Parallel to Serial Converter block 403 is disabled.

Serial to Parallel Converter block 404 is enabled.

This is performed in anticipation of a response from Slave B. Accordingly, Slave B outputs serial data SDATA via communication bus 411 to input SIN404 of Serial to Parallel Converter block 404, resulting in the outputting of parallel form of SDATA through POUT404 to PIN402 of Decoder2 402. Decoder2 402 decodes the parallel form of SDATA and sends a corresponding output to Look-up table 406 from output OUT402 to input IN406. Based on the pre-determined response to every SDATA type received, the Look-up table 406 will output the corresponding output POUT406.

Once the exemplary condition 1 has passed, the Master device 400 will decide to ‘DISABLE PSEUDO-MASTER’. This is achieved by sending an instruction via communication bus 410 to Slave A to disable its pseudo-master mode. Upon receipt of this signal, Decoder1 401 will send out a signal ENDP at output DOUT401, to cause switch SWA to open and disabling Decoder2 402, Decoder3 405 and Look-up table 406. This thus indicates the end of the Pseudo-Master mode.

### Sixth Embodiment

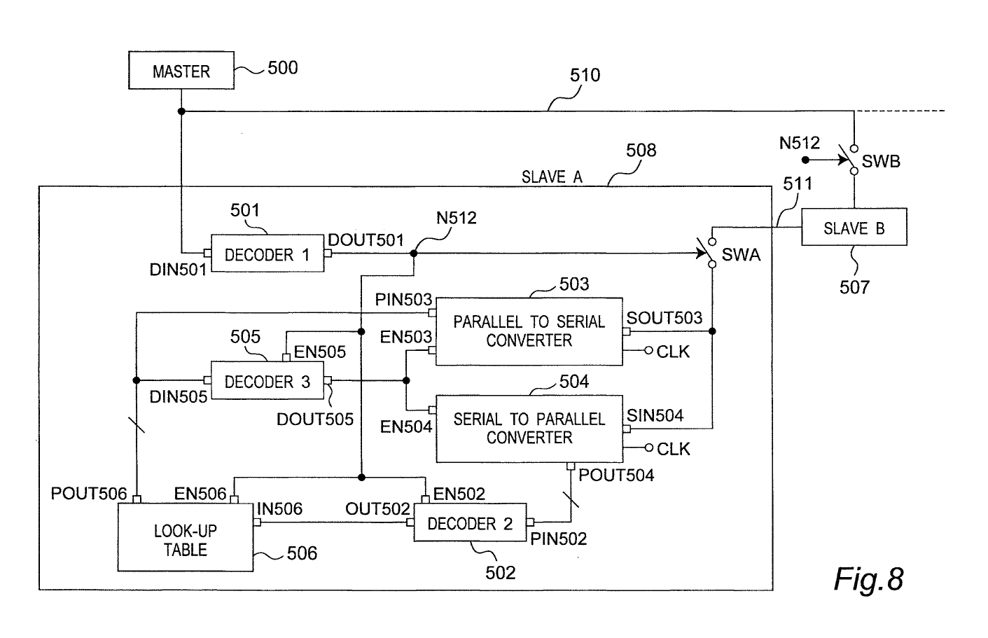

Referring to FIG. 8, an implementation to realize the sixth embodiment of the IC communication system based on the present invention is described.

As can be seen, except for the inclusion of switch SWB, the sixth embodiment is made up of the same elements as the fifth embodiment.

The working of the system is the same as the fifth embodiment, except for the additional step of opening switch SWB upon receiving the INITP signal. This has the effect of completely disconnecting the Master device from Slave B.

Likewise, when it is decided to ‘DISABLE PSEUDO-MASTER’, DOUT501 outputs the ENDP signal via node N512. This in turn will cause switch SWB to close, thus restoring the connection between the Main master device and Slave B.

### Seventh Embodiment

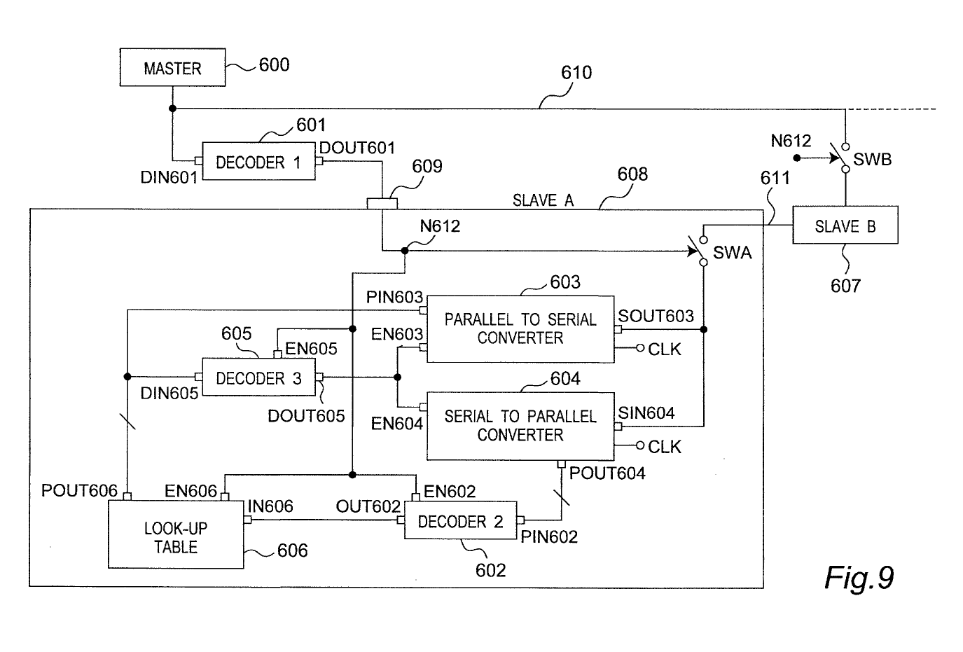

Referring to FIG. 9, an implementation to realize the seventh embodiment of the IC communication system based on the present invention is described.

As can be seen, the seventh embodiment is made up of the same elements as the sixth embodiment. The only difference being that Decoder1 601 is external to Slave A, that is, it is no longer a part of Slave A. The output of Decoder1 601 is inputted into the control terminal 609 of Slave A 608.

The working of the system is the same as the sixth embodiment.

Also, when it is decided to ‘DISABLE PSEUDO-MASTER’, DOUT601 outputs the ENDP signal via node N612. This in turn will cause switch SWB to close, thus restoring the connection between the Main master device and Slave B.

### Eighth Embodiment

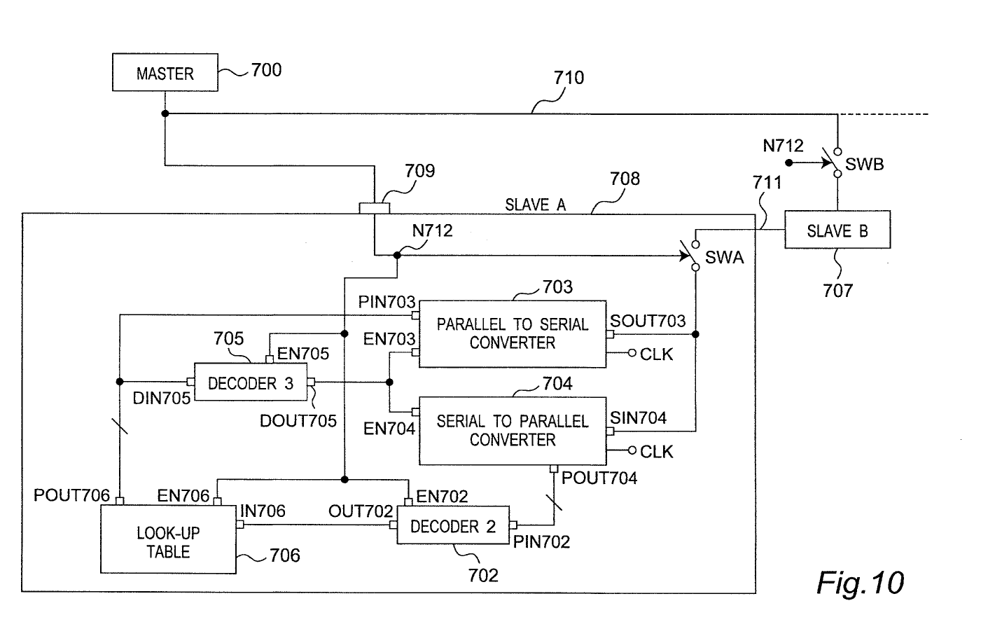

Referring to FIG. 10, an implementation to realize the eighth embodiment of the IC communication system based on the present invention is described.

As can be seen, except for the exclusion of Decoder1 601 (as used in the seventh embodiment), the eighth embodiment is made up of the same elements as the seventh embodiment.

When the Master device 700 decides to ‘ENABLE PSEUDO-MASTER’ due to certain conditions, such as exemplary condition 1, the operation of the Pseudo-Master is described as follows:

Master device 700 sends an instruction to initiate the Pseudo-Master mode via communication bus 710 to control terminal 709 of Slave A 708. Unlike in the seventh embodiment, for the eighth embodiment, the signal sent is inputted direct to the Slave A 700, without the need of a Decoder1 block as used in fifth, sixth and seventh embodiments. Hence, the Master device 700 directly communicates to enable pins EN702, EN705 and EN706 of Decoder2 702, Decoder3 705 and Look-up table 706 respectively, as well as close switch SWA. The rest of the operation is the same as that of the previously described embodiments.

Having described the above embodiments of the invention, various alternations, modifications or improvement could be made by those skilled in the art. Such alternations, modifications or improvement are intended to be within the spirit and scope of this invention. The above description is by ways of example only, and is not intended as limiting. The invention is only limited as defined in the following claims.

What is claimed is:

1. A method of optimizing the utilization of a first communication bus, comprising:
establishing a second communication bus between a first slave device and a second slave device, upon instruction by the master device;
designating said first slave device as a pseudo-master;
enabling direct communications between said first slave device, now a pseudo-master, and said second slave device;
disabling the pseudo-master status of said first slave device upon instruction by the master device; and
regaining control over said first and second slave devices by the master device.

2. The method according to claim 17 wherein said first communication bus is connected to said second slave device via a switch.

3. The method according to claim 1, wherein said second communication bus uses a conventional communication protocol, namely Inter-IC communication (IIC), Serial peripheral interface (SPI) or others already known to the industry.

4. The method according to claim 1, wherein said second communication bus uses a custom self-defined protocol.

5. The method according to claim 1, wherein said second communication bus uses the same communication protocol as the first communication bus.

6. The method according to claim 1, wherein said second communication bus uses a different communication protocol from the first communication bus.

7. A communication bus system comprising:
a master device that controls all slave devices connected to a first communication bus;
a first slave device that has the capability to act, as its secondary function, as a pseudo-master when required by said master device;
a second slave device that has been pre-determined to be a device that is to be controlled by said first slave device; and
a second communication bus that connects between said first slave device and second slave devices.

8. The communication bus system of claim 7, wherein said first communication bus is connected to said second slave device via a switch.

9. The communication bus system of claim 7, wherein said second communication bus uses a conventional communication protocol, namely Inter-IC communication (IIC), Serial peripheral interface (SPI) or others already known to the industry.

10. The communication bus system of claim 7, wherein said second communication bus uses a custom self-defined communication protocol.

11. The communication bus system of claim 7, wherein said second communication bus uses the same communication protocol as said first communication bus.

12. The communication bus system of claim 1, wherein said second communication bus uses a different communication protocol from said first communication bus.

13. A method of optimizing the utilization of a communication bus, comprising:
designating a first slave device as a pseudo-master;
enabling the pseudo-master status of said first slave device upon instruction by the master device;
disconnecting said communication bus between a master device and said first slave device, and between said master device and a second slave device;
enabling direct communications between said first slave device, now a pseudo-master, and said second slave device;
disabling the pseudo-master status of said first slave device upon instruction by the master device; and
regaining control over said first and second slave devices by the master device.

14. The method according to claim 13, wherein said master device enables and disables the pseudo-master status of said first slave by using a decoder to decode the control signal from said master device.

15. The method according to claim 13, wherein said master device enables and disables the pseudo-master status of said first slave by using a direct wired connection to said first slave device.

16. A communication bus system comprising:
a master device that controls all slave devices connected to a common communication bus;
a first slave device that has the capability to act, as its secondary function, as a pseudo-master when required by said master device;
a second slave device that has been pre-determined to be a device that is to be controlled by said first slave device; and
a switch on said common communication bus that connects the master device to said first slave device and said second slave device.

17. The communication bus system of claim 16, wherein said master device enables and disables the pseudo-master status of said first slave by using a decoder to decode the control signal from said master device.

18. The method according to claim 16, wherein said master device enables and disables the pseudo-master status of said first slave by using a direct wired connection to said first slave device.

19. The communication bus system of claim 7, wherein said first slave device comprises:
a first decoder device that decodes instructions from said master device into signals for a second decoder device, a third decoder device, a switch operative and a Look-up table device;
a second decoder device that decodes signal from a serial to parallel converter device into a form comprehensible by said look-up table device;
a look-up table device that outputs a signal corresponding to the input it receives from said second decoder device;
a third decoder device that decodes signal from said look-up table device into signals to enable and disable a parallel to serial converter device and a serial to parallel converter device;
a parallel to serial converter device that converts parallel data inputs into serial data outputs;
a serial to parallel converter device that converts serial data inputs into parallel data outputs; and
a first switch operative that opens and closes a direct communication bus from said first slave device to said second slave device.

20. The communication bus system of claim 19, wherein said first slave device further comprises:
a second switch operative that opens and closes a direct communication bus between said second slave device and said master device;
said first decoder device that decodes instructions from said master device into signals for said second decoder device, said third decoder device, said first switch operative, said Look-up table device and said second switch operative.

21. The communication bus system of claim 20, wherein said first decoder device is not a part of said first slave device.

22. The communication bus system of claim 20, wherein said first slave device further comprises:
said first decoder device is removed so that the master device sends signals directly to said second decoder device, said third decoder device, said switch operative, said Look-up table device and said second switch operative.
